(19) United States
(12) Patent Application Publication
(10) Pub. No.: US 2002/0117026 A1
(43) Pub. Date: Aug. 29, 2002

(54) Modular die board system

(76) Inventor: Long Chang, Irvine, CA (US)

Correspondence Address: Mr. Gene Scott, Patent Law & Venture Group, 3151 Airway Ave., Suite K-105, Costa Mesa, CA, 92626, US

(21) Appl. No.: 09/794,834

(22) Filed: Feb. 27, 2001

(51) Int. Cl. B26F 1/44; B21K 5/20

(52) U.S. Cl. 76/107.8; 83/698.71

(57) ABSTRACT

A modular die board apparatus comprises a plurality of rectangular support plates mutually positioned in an abutting relationship along peripheral edges. Each of the support plates provides a plurality of evenly-spaced apart, first apertures arranged in rows adjacent to, and in parallel-with, the peripheral edges. A plurality of fasteners, each providing parallel, spaced-apart legs depending from a bridge are adapted for frictional engagement with one of the first apertures in each of two adjacent of the support plates so as to hold them in rigid abutment and alignment. The support plates have a plurality of second apertures alternately spaced with a plurality of linear cuts forming a selected pattern within the support plates. A plurality of die impact effectors such as scorers and cutters are removably engaged within the second apertures and linear cuts and extend above a top surface of the support plates for contact with a workpiece.

### BACKGROUND OF THE INVENTION

1. Field of the Invention

This invention relates generally to die cutting board assemblies and more particularly to a modular die board system adapted for expansion through mechanical chaining of new modules to existing assemblies.

2. Description of Related Art

The following art defines the present state of this field:

Jenkins, U.S. D274,335 describes the ornamental design for a die cutting apparatus.

Rickenbacker, U.S. Pat. No. 3,635,115 describes a punching device for cutting sheet-type layer pieces having mutually adjustable knife plates and means for adjusting the knife plates to cut pieces from the sheet of desired sizes.

Saunders, U.S. Pat. No. 3,673,929 describes a creasing rule for a rotary cutting die. The creating rule is used to produce and indented line in a corrugated board, along which line the corrugated board is to be folded subsequently, when formed into a final product, such as a container. The cutting die comprises a curved die plate fastened on a rotatable cylinder with the creasing rule mounted in the die plate. The new creasing rule includes a base or flange which extends through the die plate to contact and be backed up by the cylinder, which then positions the creasing rule at a fixed distance from the surface of the cylinder, even with a variation in the thickness of the die plate. Further, the creasing rule is designed with a broad tapered web on each side of an indenting ridge which produces the indented line, so that the possibility of breaking of the liner of the corrugated board when the indentation is made is minimized.

Castille, U.S. Pat. No. 3,752,042 describes a system of four arcuate dies are adapted to be mounted in evenly spaced threaded holes in a rotary cylinder for a cardboard box fabricating machine. The positions of three of the dies are adjustable either longitudinally or circumferentially, or both, on the rotary cylinder whereby the dimensions of the cardboard boxes manufactured may be varied infinitely. Further, the position of a single die plate on the rotary cylinder may be adjusted both longitudinally and circumferentially of the rotary cylinder to an infinite number of positions.

Jones et al., U.S. Pat. No. 3,826,170 describes a cutting blade system for cutting sheet material into pieces of generally the same contour but of different sizes, especially useful in the manufacture of apparel for cutting cloth into pieces to be sewn together into garments. The system involves a set of primary cutting blade segments common to all sizes of a piece of given contour or pattern to be cut out of the sheet material and a set of auxiliary cutting blade segments additive to (or subtractive from) the primary segments to constitute cutting blade assemblies of different sizes in the stated contour or pattern. The segments are made of steel rule die stock, are releaseably held together in assembly, and assemblies of segments in various patterns are utilized in a hydraulic press for die-cutting through one or more layers of material in the press. The press may have an electromagnetic head for magnetically gripping the assemblies for the cutting operation and for quickly releasing them after the cutting operation whereupon the assemblies may be disassembled and the primary segments reassembled with auxiliary segments in a different size.

Young, Jr. et al., U.S. Pat. No. 3,835,746 describes an improved die assembly having easily replaceable rule. A plate or roll directly receives on or more sections of rule according to a predeterined design or shape. The rule is thin elongated strip metal having a flat underside and an upperside that is sharp, radiused or otherwise prepared to perform a particular function on a material. The flat underside of the cutting rule is directly in contact with the backing plate or roll or a resilient cover positioned thereon. Removable, resilient mounting means apply a spring force against the rule to hold same against a rigid support in proper position for die cutting, creasing or the like. Removability of the resilient mounting means permits redy replacement of damaged or dulled cutting rule without any undue expense or appreciable production loss. Mounting means for the rule are also claimed, and include a rigid support and a resilient support to receive rule therebetween. The resilient support has at least one spring secured thereto and extending outwardly therefrom. The end of the support when in position defines the thickness of the rule and the spring system extends outwardly therefrom. The spring system is deformed by the rule upon insertion of the rule from above an continually applies a spring force against the rule to hold same in place.

Gendron, U.S. Pat. No. 3,929,059 describes a reusable make-ready or counter plate for cutting and scoring boxboard to form carton blanks. The reusable make-ready or counter plate comprises a mounting plate that is detachably mountable on the press and at least on cutting plate which is adapted to co-operate with knives and creasing rules on a male die to form a carton blank. The cutting plates are releaseably retained on the mounting plate.

Bishop, U.S. Pat. No. 3,941,038 describes a forme construction for a die cutting apparatus in which cutting rule is supported in slots in a relatively massive support plate by using sinuous resilient elements lying between walls of slots in the support plate and the sides of the rule.

Quinlan, U.S. Pat. No. 4,020,724 describes a rotary cutting die adapted to be mounted on a rotatable cylindrical die drum of a rotary press to cut a planar object passed between such rotating die drum and a cooperative oppositely-rotating anvil drum of said press. The rotary die includes: a die board having a concave surface adapted to cover a portion of the die drum, an opposite convex surface, and a plurality of openings therethrough; a plurality of fasteners adapted to selectively hold the die board to the die drum; a plate-like knife member adapted to be mounted on the die board at any of a plurality of large incremental positions in a longitudinal direction; and holding means mounted on the die board and selectively operable to hold the knife member at any selected one of the large incremental positions. In one embodiment, the die board openings are longitudinally-elongated to permit the die board to be shifted longitudinally relative to the die drum. In another embodiment, the die board openings are circumferentially-elongated and uniquely spaced from one another in a longitudinal direction such that some of the die board openings will register with some of the die drum holes at any of a plurality of discrete positions in a longitudinal direction. In this embodiment, compound movement of the die board and the knife member enables the knife edge to be selectively positioned along the die drum at any of a plurality of small incremental positions.

Sauer et al., U.S. Pat. No. 4,103,580 describes a method of and apparatus for developing on tape and applying a pre-selected die design, etc., defined by spaced drilled holes, to a die board automatically by a tape controlled apparatus, and to automatically produce properly dimensioned cutting rule for the design. A computer is programmed to produce information which is transferred to a tape, or the like, fed to a numerical control machine to energize selected mechanisms to physically apply a pre-selected design formed by spaced drilled holes, routing, etc., to a die board for reception of spaced tangs or legs of cutting rule, or the like, or other workings. The information from the computer also is utilized, by means of an intermediate tape or the like, to energize a numerically controlled cutting rule machine to automatically produce cutting rule segments of the proper number and length for mounting in the drilled design on the cutting board. Included in the computer programming is a foreshortening of dimensions, if required, to compensate for the relative position of the cutting rule edge in arcuate die boards. Illustrated is an exemplary apparatus for punching cutting rule and for drilling or drilling and routing rotary die board including an electrically actuatable structure for rotatably supporting rotary die board, an electrically actuatable traversable supporting structure for a drill head, and an electrically actuatable drill head adapted to execute desired reciprocable movements and to drill spaced holes and to rout, as signaled.

Bittner, U.S. Pat. No. 4,674,168 describes a method and a disc cutter machine for carrying out the method with which the previously strenuous blade receiver exchange is simplified and facilitated, it is provided that the blade receiver to be exchanged is tilted up by means of a tilting arrangement with its end facing the outer side of the disc cutter, received by a guide and drawn out substantially in the radial direction along the guide from the region of the disc cutter and then the new blade receiver is inserted along the guide into the disc cutter.

Ireland, U.S. Pat. No. 4,945,751 describes a portable reinforcing rod cutter and bender. A cutting die having elongate and oblique holes for receiving a plurality of rods to be sheared cooperates with a cutting blade connected to a hydraulically operated ram. A female bending die having a pair of pivoting die blocks cooperates with an anvil to bend rods of different diameter to bends having different angles and different diameters. The cutter and bender includes a first gauge for measuring bend angles and a second gauge for measuring the length of rods being bent or sheared. The cutting blade, cutting die, bending die, and anvil are readily removable to allow replacement thereof and to bend and shear different types and sizes of rods and pipes to different bend angles and bend diameters.

Knudson, U.S. Pat. No. 4,981,060 describes a roll forming apparatus having a series of roll forming stations with a first group of stations having rollers that are adjustable to different width settings using the same rollers to form more than one width of ogee type gutter. A cutter uses interchangeable cutting blades and die plates for shearing different gutter sizes to selected lengths. The cutter uses a rotary drive member to move the blade in a path having a relatively short stroke that performs a scissor-like cutting action to successively cut the walls of the formed gutters for each revolution of the rotary drive member. A crank member for manually moving the cutter blade is collapsible and the crank handle is demountable for transport purposes.

Holliday, U.S. Pat. No. 5,029,505 describes an apparatus having improved retention of steel rule dies inserted into slots of a retaining board. A plurality of chambers are oriented substantially perpendicularly to the direction of insertion and have open faces to permit communication with the slots. A spring is located within each chamber and is connected to a ball shaped member located at the open face. Upon initial insertion of the die, the ball shaped member causes the spring to compress. Once the die is completely inserted, the ball/spring assembly exerts a normal force against the die in the direction of the slot wall opposite the open face. Accordingly, the inserted steel rule dies are securely held within the slots.

Simpson, U.S. Pat. No. 5,221,249 describes a creasing rule used in connection with a steel rule cutting die to form creases or fold lines in a blank cut from a sheet material, such as corrugated paper board. The creasing rule includes a base portion which fits into the slot of a die board, and a top portion which extends outwardly from the surface of the die board. The top portion terminates in a creasing edge, which, in cooperation with an anvil roll, compresses the sheet material to form a crease or fold line in the sheet material. The creasing edge of the creasing rule is formed with a plurality of undulations giving the creasing edge a generally sinusoidal form. The undulations on the creasing rule taper inwardly towards the plane of the base portion as the undulations extend from the creasing edge towards the base portion and finally merge into the flat base portion. The size or magnitude of the undulations can be varied depending on the thickness of the sheet material being used. Additionally, the pitch of the undulations (i.e. the number of undulations per linear inch) can be varied as desired to produce fold lines requiring different amounts of force and fold relief to bend.

Ury, U.S. Pat. No. 5,293,799 describes a punching and perforating cylinder and a die and anvil cylinder that are part of a computer paper processing system producing the line holes and the cross perforation in a continuous paper web. The PUNCH/PERF cylinder is mounted on an upper shaft, while the DIE/ANVIL cylinder is mounted on a lower shaft. The upper and lower shafts are rotatably engaged by a set of gears. At both ends of the PUNCH/PERF cylinder, holes are located to accept the PUNCHES. At both ends of the DIE/ANVIL cylinder, holes are located to accept the DIES. While the two cylinders are rolling together, the punches engage with the dies and form the punched line holes in the continuous paper web. The PUNCH/PERF cylinder has longitudinally formed slots, providing the space for the cross perforating blades and for the cross perforating blade clamping bars. The DIE/ANVIL cylinder has longitudinally formed slots, providing the space for the hardened anvil bars. While the two cylinders are rolling, the cross perforating blades are engaged with the anvil bars and form the cross perforation in the continuous paper web. At both ends of the cross perforating blade locking bars, holes are located to accept the punches, providing the punch hole locations in the cylinder, circumferentially. At both ends of the anvil bars, holes are located to accept the dies, providing the die hole locations in the cylinder, circumferentially. The combined punching and perforating cylinder set enables it to complete both the punching and perforating operations in a continuous paper web by only one set of rotating cylinders.

Michlin, U.S. Pat. No. 5,566,594 describes a re-rulable steel rule die frame is made from metal. Slots are cut in the metal die frame for receiving the blades of the steel rule. In one embodiment, the frame is a block of metal and the slots are cut such that the slots do not go completely through the frame. The blades are placed in the slots to form the desired cutting configuration. The edges of the blades opposite the cutting edges rest on the metal bottoms of the slots. The comers or ends of the blades are joined by welding, brazing or soldering without danger of burning the metal frame. In another embodiment, computer-directed laser beams cut precise slots in multiple layers of metal. The multiple layers are then joined together so the slots align, providing a precisely cut metal-framed steel rule die of a thickness able to withstand repeated stress. A modification of this embodiment allows the cut material to fall through the die. The desired shape is precisely cut in each frame layer, forming openings through each layer. The layers are joined together so the openings align. The steel rule blades are brazed to the metal frame layers around the perimeter of the formed opening. When the material is cut it falls through the frame. As an alternative to the openings, compressed air ejection system is used to remove the cut work piece from the die frame.

Simpson et al., U.S. Pat. No. 5,582,571 describes an apparatus and method for perforating and creasing a paperboard sheet utilizing a rotary die process. The method and apparatus employ a die rule that comprises a base adapted to be attached to a die roll of a rotary die machine, a plurality of tooth elements, and open spaces between at least some of the plurality of tooth elements. Each of the plurality of tooth elements comprises a body portion that is fixed to and extends radially outwardly from the die roll and a laterally-tapered tooth portion. Each open space is defined by lateral portions of adjacent teeth element body portions and by the base outer edge. The body portion preferably extends radially outwardly from the base so that substantially all of the tooth portion penetrates the outer surface of the paperboard, and the base outer edge extends outwardly so that it engages and creases the inner surface of the paperboard. It is also preferred that the lateral portions of the tooth element body portions are substantially perpendicular to adjacent open spaces so that perforations formed on the paperboard inner surface are substantially the same length as those formed in the paperboard outer liner.

Johnson, U.S. Pat. No. 5,676,032 describes a steel rule cutting die for cutting fixed patterns in a single or plurality of stacked material layers according to the shape of the steel rule. The invention provides for a decrease in the quantity of scrap material produced, by minimizing the amount of gap between adjacent cavities in the steel rule cutting die. Pre-sharpened steel rule is used with the cutting edge shifted to the outboard side of the cavity thus reducing the amount of compression or wedging of scrap material between adjacent cavities, and thus allowing adjacent cavities to be positioned closer to one another or to contact one another without reducing the ability to remove the scrap material after the cutting operation. Frayed scrap material can be evacuated through the base of the die by providing evacuation holes in the base substrate of the die as well as providing for evacuation of scrap material from marker notch locations along joined sections of adjacent cavities. A variety of cavity shapes can be accommodated.

Guez, U.S. Pat. No. 5,743,164 describes an automatic reconfigurable die having an array of knives, each of which is separately pivoted and extended along and about a respective longitudinal axis, to allow a desired contour to be scored and cut from a sheet material, according to a real time computer plan which is controlling the array of knives. The automatic reconfigurable die includes actuators associated with each knife to control, via information associated with a remote computer system, the extension and retraction, and orientation of the knives. The computer selects the appropriate set points for each knife in order to match the required shape/pattern of the cut by simple curve fitting methods. In this manner, a selected plurality of the knives in the array are chosen, oriented and extended in real time to score/cut the selected part.

Brayton et al., U.S. Pat. No. 5,943,9365 describes a lightweight, dimensionally stable steel rule die for cutting and scoring carton blanks having a die board containing the cutting and scoring rules which is formed of a laminated plastic construction adapted to register and coact with a steel counterplate over prolonged production runs and maintain registration within a tolerance range of about.+−.0.002 inches.

Johnson, U.S. Pat. No. 5,983,766 describes a steel rule die for cutting cloth and synthetic materials. The cutting die includes a primary substrate and a plurality of cutting units that are removably attachable to the substrate in such a manner that they are easy to adjust, remove and replace. The cutting units include secondary substrates with lengths of steel rule attached to them to form cutting cavities. Studs mounted to the primary substrate interface with tear-drop shared holes in the secondary substrates with to restrain them against motion perpendicular to the surface of the primary substrate while permitting movement of the cutting units in a horizontal plane with respect to the primary substrate. Adjustable securing rails positioned along the peripheries of the primary substrate are moved toward the fixed securing rails to restrain the secondary substrates against lateral and longitudinal motion. By moving the adjustable securing rails away from the fixed securing rails, the cutting units can be temporarily moved away from each other for cleaning scrap material therebetween. Foam can be disposed between the cutting units to minimize the possibility of scrap material becoming lodged between the cutting units, and aid in the removal of any scrap material that happens to become lodged between the cutting units.

The prior art teaches a broad range of die board constructions, however, the prior art does not teach the present system of modules and interconnecting fasteners enabling ready configuration, reconfiguration and expansion of existing modular assemblies. There clearly is a need for a modular die cutting board assembly system that can be reused and reconfigured many time in a simplified and cost effective manner.

### SUMMARY OF THE INVENTION

The present invention teaches certain benefits in construction and use which give rise to the objectives described below.

As well defined in the references cited above modular die boards are broadly used. However, a modular system that comprises a plurality of rectangular wooden support plates mutually positioned in an abutting relationship along peripheral edges and fastened as needed for particular applications is not known. Typically new boards must be made up even if a small change in configuration is required. The present invention enables additions, subtractions and changes to be made easily and quickly at relatively low cost. Each of the support plates provides a plurality of evenly-spaced apart, first apertures arranged in rows adjacent to, and in parallel with, the peripheral edges. A plurality of fasteners, each providing parallel, spaced-apart legs depending from a bridge are adapted for frictional engagement with one of the first apertures in each of two adjacent of the support plates so as to hold them in rigid abutment and alignment. The support plates have a plurality of second apertures alternately spaced with a plurality of linear cuts forming a selected pattern within the support plates. A plurality of die impact effectors such as scorers and cutters are removably engaged within the second apertures and linear cuts and extend above a top surface of the support plates for contact with a work piece.

A primary objective of the present invention is to provide an apparatus and method of use of such apparatus that provides advantages not taught by the prior art.

Another objective is to provide such an invention capable of being easily adapted to various configurations.

A further objective is to provide such an invention capable of a wide range of configurations.

A still further objective is to provide such an invention capable of being made at low cost.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a partial perspective view of the invention showing a fastener of the invention positioned for insertion into first apertures of the invention;

FIG. 2 is similar to FIG. 1 showing the fastener inserted into the apertures;

FIG. 3 is an exploded perspective view of the invention;

FIGS. 4 and 5 are perspective views thereof showing the modular interchangeability of the invention system;

FIG. 6 is a plan view of a top surface of the invention as assembled from 18 individual modules; and

FIG. 7 is a plan view of various configurations of the fastener of the invention.

### DETAILED DESCRIPTION OF THE INVENTION

The above described drawing figures illustrate the invention, a modular apparatus for die cutting paper and paperboard sheet products as is known in the art.

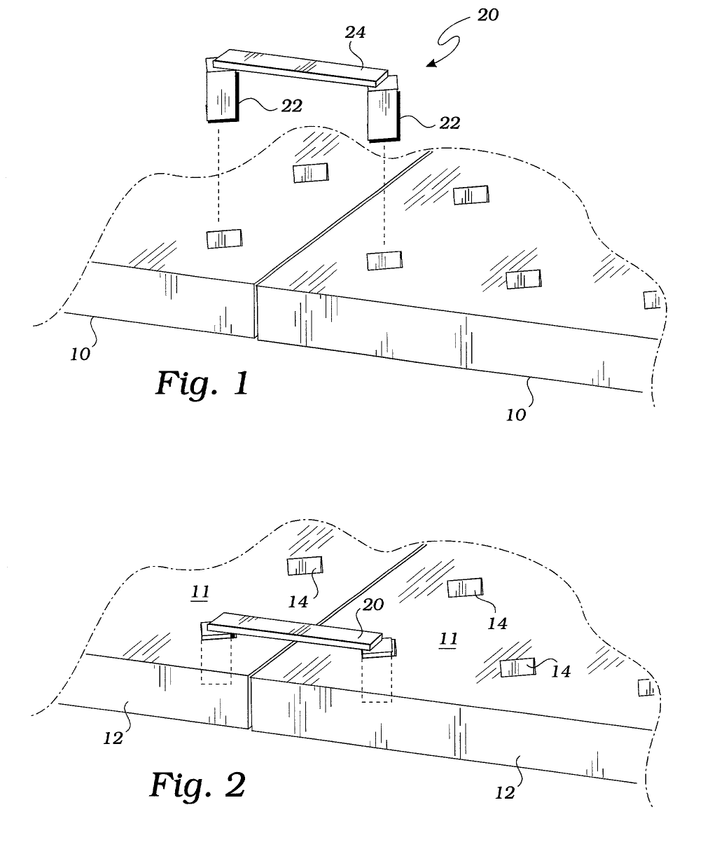

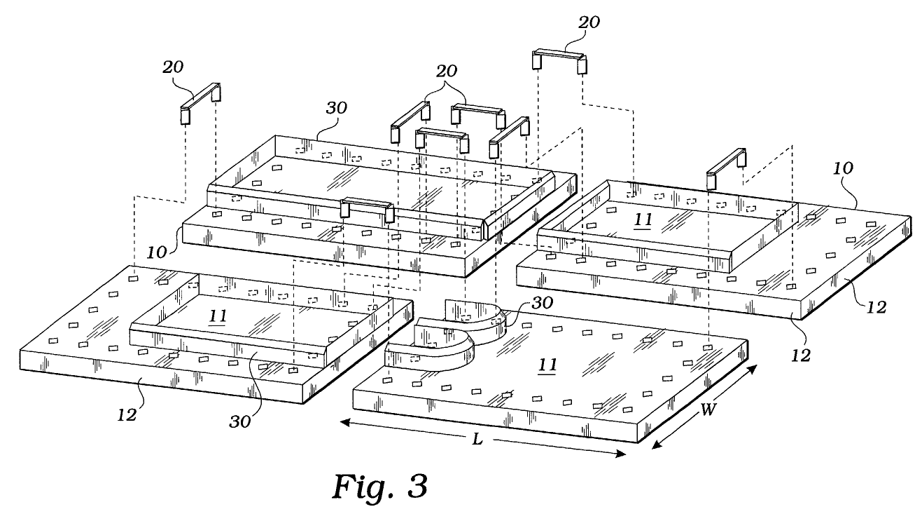

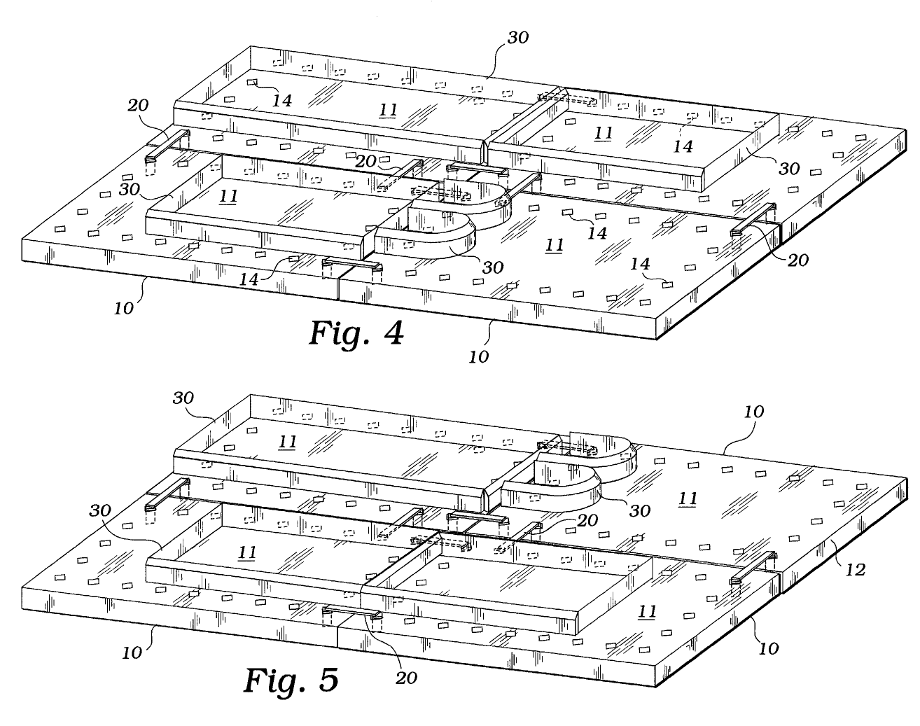

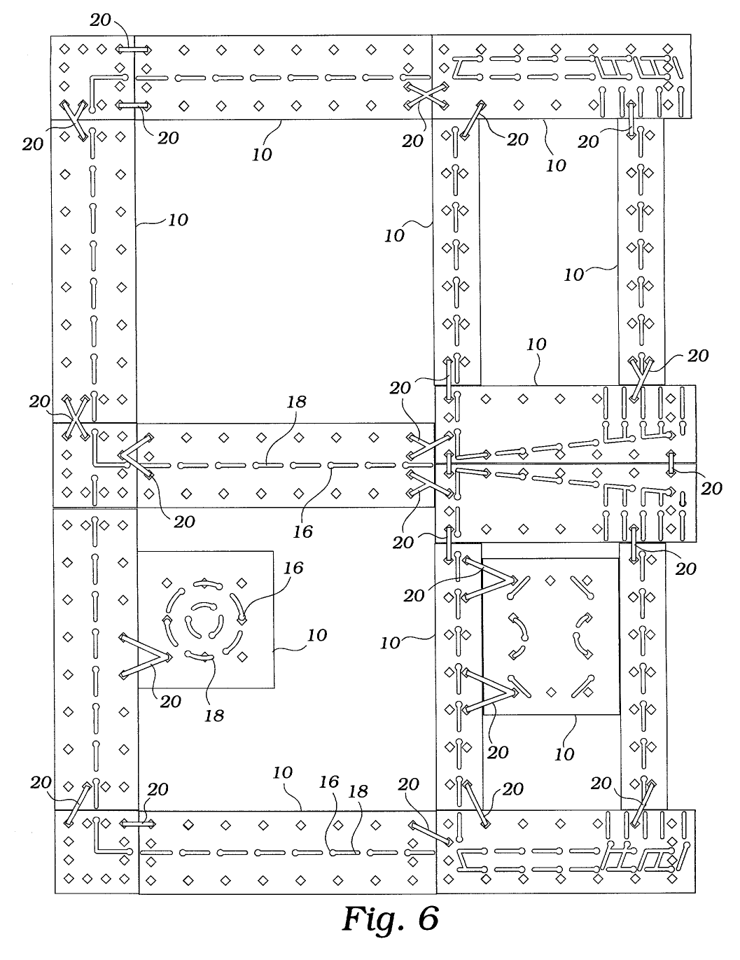

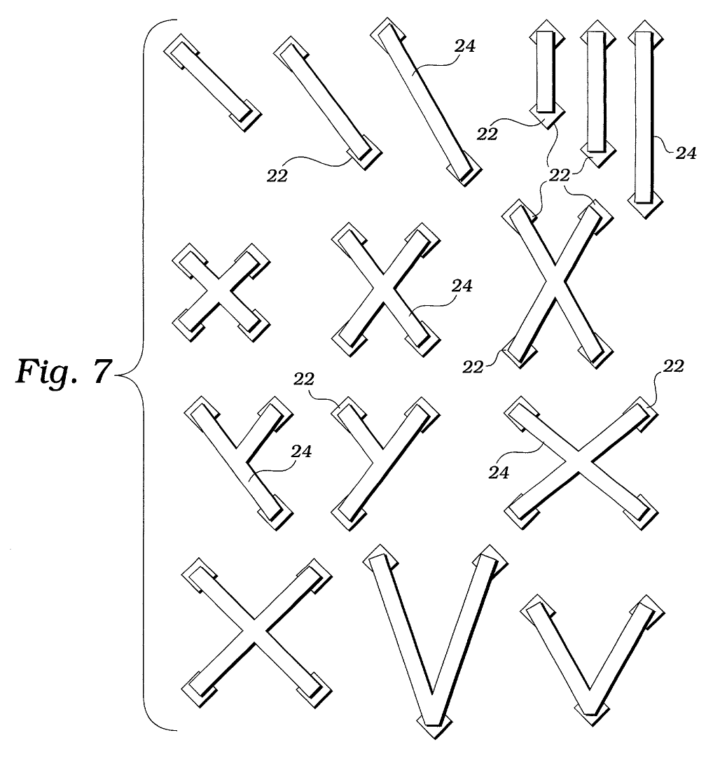

A modular die board system comprises a plurality of rectangular support plates 10 which are preferably made of wood laminates approximately ⅝ inch in thickness. Each of plates has a specific width W and length L dimension and such may vary over a range; see FIG. 3 & 6. These width and length dimensions are held or restricted to specifically allowed values and such are preferably in ½ inch increments or other scheme. This particular scheme, using ½ inch increments, as been discovered to provide greatly superior results when applied to the types of paper product type die cutting for the stationary industry. When the increment is smaller it tends to require too large a number of different sized support plate blanks for the range of applications in use. When the increment is larger than ½ inch the ability to assemble systems with fine enough details tends to be lost. Therefore, ½ inch increments, or thereabout, has been found to result in superior results and is considered to be an important inventive element in the present invention. FIG. 6 shows a die made from 18 separate support plates 10 where it can be seen that such plates 10 may be of various sizes and shapes. From the plurality of support plates 10 the die of FIG. 6 represents only one possible assembly (or subset) of such plates 10 so that literally, an quite large number of dies may be constructed from such support plates 10. The support plates 10, are mutually positioned in an abutting relationship along their peripheral edges 12 as shown in FIGS. 1 and 2. Each of the support plates 10, provides a plurality of evenly-spaced apart, first apertures 14 arranged in rows adjacent to, and in parallel-with, the peripheral edges 12.

A plurality of fasteners 20 is used to connect the plates 10. Each one of the fasteners 20, preferably made of hard steel or plastic, provides parallel, spaced-apart legs 22 depending from a bridge 24, as best seen in FIG. 1, and these legs 22 are adapted by their size for frictional engagement with at least one of the first apertures 14 in each of two adjacent support plates 10 so as to hold them in rigid abutment and alignment.

The support plates 10 further provide a plurality of second apertures 16 alternately spaced with a plurality of linear cuts 18 forming a selected pattern within the support plates 10. The linear cuts 18 are typically about 1/32 inch in width. A plurality of die impact effectors 30 is removably engaged within at least a subset of the second apertures 16 and linear cuts 18 and extends above a top surface 11 of the support plates 10 for contact with a work piece (not shown). Such effectors 30 are typically steel strips which are friction fitted into the linear cuts 18 of the plates 10 and the terminal outwardly directed edge of these steel strips are dull for scoring a paper work piece surface or knife edged for cutting the paper work piece. Rubber bumpers are commonly used in such die cutting operations to release the paper work piece from the cutting edges, but are not shown in the illustrations.

The first apertures are preferably square, or other non-round holes and the legs of the fasteners are of a preferably corresponding shape so as to be manually pressed into these holes. The bridge 24 of the fasteners 20 may be I, V, Y or X shaped (or others) and the fastener might than provide between 1 and 4 legs or more. Clearly, such complex fasteners provide added fastening strength and rigidity when building-up such a modular system.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A modular die board apparatus comprising a plurality of rectangular support plates mutually positioned in an abutting relationship along peripheral edges thereof, each of the support plates providing a plurality of evenly-spaced apart, first apertures arranged in rows adjacent to, and in parallel-with, the peripheral edges; a plurality of fasteners, each one of the fasteners providing parallel, spaced-apart legs depending from a bridge, the legs adapted for frictional engagement with one of the first apertures in each of two adjacent of the support plates so as to hold the two adjacent of the support plates in rigid abutment and alignment; the support plates further providing a plurality of second apertures alternately spaced with a plurality of linear cuts forming a selected pattern within the support plates; and a plurality of die impact effectors removably engaged within at least a subset of the second apertures and linear cuts and extending above a top surface of the support plates for contact with a work piece.

2. The apparatus of claim 1 wherein the first apertures are non-round holes and the legs of the fasteners are of a shape to be manually pressed into the non-round holes.

3. The apparatus of claim 1 wherein the bridge of at least one of the fasteners is I-shaped and the fastener has 2 legs.

4. The apparatus of claim 1 wherein the bridge of at least one of the fasteners is V-shaped and the fastener has 3 legs.

5. The apparatus of claim 1 wherein the bridge of at least one of the fasteners is Y-shaped and the fastener has 3 legs.

6. The apparatus of claim 1 wherein the bridge of at least one of the fasteners is X-shaped and the fastener has 4 legs.

7. A modular die board system comprising a plurality of rectangular support plates providing width and length dimensions held to an incremental dimension, each subset of the plurality of rectangular support plates mutually positioned in an abutting relationship along peripheral edges thereof, each of the support plates providing a plurality of evenly-spaced apart, first apertures arranged in rows adjacent to, and in parallel-with, the peripheral edges; a plurality of fasteners, each one of the fasteners providing parallel, spaced-apart legs depending from a bridge, the legs adapted for frictional engagement with one of the first apertures in each of two adjacent of the support plates so as to hold the two adjacent of the support plates in rigid abutment and alignment; the support plates further providing a plurality of second apertures alternately spaced with a plurality of linear cuts forming a selected pattern within the support plates; and a plurality of die impact effectors removably engaged within at least a subset of the second apertures and linear cuts and extending above a top surface of the support plates for contact with a work piece.

8. The apparatus of claim 7 wherein the first apertures are non-round holes and the legs of the fasteners are of a shape to be manually pressed into the non-round holes.

9. The apparatus of claim 7 wherein the bridge of at least one of the fasteners is I-shaped and the fastener has 2 legs.

10. The apparatus of claim 7 wherein the bridge of at least one of the fasteners is V-shaped and the fastener has 3 legs.

11. The apparatus of claim 7 wherein the bridge of at least one of the fasteners is Y-shaped and the fastener has 3 legs.

12. The apparatus of claim 7 wherein the bridge of at least one of the fasteners is X-shaped and the fastener has 4 legs.
